(19) United States
(12) Patent Application Publication
(10) Pub. No.: US 2022/0231465 A1
(43) Pub. Date: Jul. 21, 2022

(54) Male Connector, Female Connector, Connector Assembly, and Communications Device

(71) Applicant: Huawei Technologies Co., Ltd., Shenzhen (CN)

(72) Inventors: Zhigang Zhao, Dongguan (CN); Kou Xu, Dongguan (CN); Jie Zhang, Dongguan (CN)

(21) Appl. No.: 17/716,413

(22) Filed: Apr. 8, 2022

Related U.S. Application Data
(63) Continuation of application No. PCT/CN2020/120423, filed on Oct. 12, 2020.

(30) Foreign Application Priority Data
Oct. 12, 2019 (CN) 201910969960.1

(51) Int. Cl. H01R 13/6587; H01R 13/514

(52) U.S. Cl. CPC H01R 13/6587; H01R 2107/00; H01R 2201/04; H01R 13/514

(57) ABSTRACT

A male connector, including a male conductive base (MCB), having at least two first through-holes, including at least two shielding sleeves fastened on the male conductive base and electrically connected to the male conductive base, where each shielding sleeve defines a front-to-back through shielding cavity connected to a corresponding first through-hole of the at least two first through-holes, and further including at least two male differential pairs, wherein each male differential pair of the at least two male differential pairs is fastened in the shielding cavity through at least one of the at least two first through-holes, and where each male differential pair is electrically insulated from the male conductive base and the shielding sleeve.

### CROSS-REFERENCE TO RELATED APPLICATIONS

This application is a continuation of International Patent Application No. PCT/CN2020/120423 filed on Oct. 12, 2020, which claims priority to Chinese Patent Application No. 201910969960.1 filed on Oct. 12, 2019. The disclosures of the aforementioned applications are hereby incorporated by reference in their entireties.

### TECHNICAL FIELD

This application relates to the field of connector technologies, and in particular, to a male connector, a female connector, a connector component, and a communications device.

### BACKGROUND

A high-speed connector is a key component of a communications device, and is a basis for improving rates and capacities of all information and communications technology (ICT) devices. As a transmission rate increases, crosstalk between differential pairs within a connector deteriorates. Therefore, improving crosstalk between differential pairs becomes a key problem that needs to be resolved during rate upgrade of the high-speed connector.

To resolve a crosstalk problem, a conventional method is to dispose a large quantity of metal shielding sheets on a plastic base to surround as many signal terminals as possible, and ground the metal shielding sheets, so that different differential pairs are separated, and mutual interference between different differential pairs is reduced.

The connector in the foregoing structure has a relatively large quantity of parts, the structure is complex, and there are problems of complex processing and poor consistency. In addition, because the plastic base is nearly emptied, mechanical strength is poor. In a mating process, a problem of being damaged due to a reversed pin is easily caused, and 360-degree full shielding cannot be implemented.

### SUMMARY

This application provides a male connector, a female connector, a connector assembly, and a communications device. Compared with a connector in a conventional technology, the connector provided in this application has advantages such as convenient processing, great mechanical strength, and a good shielding effect.

According to a first aspect, a male connector is provided, and includes: a male conductive base, where a plurality of first through-holes are disposed on the male conductive base, a plurality of shielding sleeves fastened on the male conductive base and electrically connected to the male conductive base, where the shielding sleeve is in a sleeve-shaped structure, a front-to-back through shielding cavity is formed inside the shielding sleeve, the plurality of shielding sleeves are in one-to-one correspondence with the plurality of first through-holes, and the shielding cavity is connected to a corresponding first through-hole, and a plurality of male differential pairs, where the plurality of male differential pairs are in one-to-one correspondence with the plurality of shielding sleeves, the male differential pair is fastened in the shielding cavity through the first through-hole, and the male differential pair is electrically insulated from the male conductive base and the shielding sleeve.

Both the male conductive base and the shielding sleeve of the male connector provided in this application have a conducting capability, and the male differential pair is fastened inside the first through-hole and the shielding cavity. The male conductive base and the shielding sleeve can entirely bind electromagnetic wave radiation generated by each male differential pair to a corresponding first through-hole and a corresponding shielding cavity, to implement 360-degree full shielding for each male differential pair, so that crosstalk does not occur between different male differential pairs.

Compared with a conventional male connector in which a plurality of shielding sheets are disposed on a plastic base, the male connector provided in this application has a simple structure and few parts, and is easy to produce and process. This facilitates a miniaturization design of a product. In this application, the shielding sleeve fastened on the male conductive base is in a sleeve-shaped structure. Compared with a conventional structure in which a plurality of shielding sheets are inserted into a plastic base, the male connector provided in this application has greater mechanical strength, and is not damaged due to a reversed pin in a process of being inserted and mated to a female connector.

In a possible design, the male connector further includes an insulated positioning piece, and the male differential pair is fastened in the shielding cavity by using the insulated positioning piece. The insulated positioning piece is made of an insulated material. When the male differential pair is reliably fastened in the shielding cavity, the male differential pair and the shielding sleeve can be separated from each other, so that the male differential pair and the shielding sleeve are electrically insulated.

Optionally, for ease of mounting, the insulated positioning piece may be made of an elastic insulated material, such as an elastic rubber material.

Optionally, the insulated positioning piece includes two parts that are connected to each other, and the two parts are a terminal retaining portion that is mounted at a front end and an embedded portion that is mounted at a rear end.

In a possible design, at least one grounding connection piece is disposed on the male conductive base. Through the foregoing disposing, it can be ensured that the male conductive base is reliably grounded. For example, a plurality of grounding connection pieces may be disposed on a rear end face of a base plate, and the grounding connection pieces can be inserted into an external circuit board. Optionally, the grounding connection piece is in a fish-eye structure.

In a possible design, the male conductive base and the shielding sleeve form an integrated structure by using an integrated molding process. Therefore, mechanical strength of the male connector can be improved.

In a possible design, the male conductive base and the shielding sleeve are made of a metal material.

In a possible design, the male conductive base and the shielding sleeve are made of a non-conductive material doped with conductive particles.

In a possible design, the male conductive base and the shielding sleeve each include a non-conductive substrate structure and a conductive layer, and the conductive layer is located on a surface of the non-conductive substrate structure.

According to a second aspect, a female connector is provided, and includes: a female conductive base, where a plurality of shielding slots are disposed on the female conductive base, and the shielding slot is in a sleeve-shaped structure, and a plurality of differential modules, where the plurality of differential modules are mounted on the female conductive base, the differential module includes a plurality of female differential pairs, the plurality of female differential pairs are in one-to-one correspondence with the plurality of shielding slots, a front end portion of the plurality of female differential pair extends into the shielding slot, and the female differential pair is electrically insulated from the female conductive base.

The female connector provided in this application includes the female conductive base, and the plurality of shielding slots are formed on the female conductive base. The female conductive base can bind electromagnetic wave radiation generated by a differential pair on each path to the shielding slot, so that crosstalk does not occur between differential pairs on different paths, and therefore signal transmission performance of the connector is improved.

In addition, the female conductive base in this application can perform an electromagnetic shielding function. Therefore, no additional shielding part (for example, a metal shielding sheet) needs to be disposed. In this way, a structure of the female connector is simplified, processing difficulty is reduced, and a miniaturization design of a product is facilitated.

In a possible design, the female conductive base includes a conductive bezel, a first conductive separator, and a second conductive separator, the first conductive separator and the second conductive separator are located inside the conductive bezel, and the first conductive separator and the second conductive separator are disposed in a cross manner to define the plurality of shielding slots.

In a possible design, the female conductive base further includes a conductive positioning baffle, the conductive positioning baffle is disposed inside the female conductive base and is located between the shielding slot and the differential module, second through-holes in one-to-one correspondence with the plurality of shielding slots are disposed on the conductive positioning baffle, and the front end portion of the female differential pair extends into the shielding slot through the second through-hole.

In a possible design, at least one third conductive separator is disposed on a side face that is of the conductive positioning baffle and that faces the differential module, and the third conductive separator is configured to separate two adjacent differential modules.

In a possible design, the differential module further includes a shielding bridge, and a front end portion of the shielding bridge abuts against the conductive positioning baffle.

In a possible design, the differential module further includes a terminal supporting portion, and the terminal supporting portion is configured to support the front end portion of the female differential pair, and extends into the shielding slot together with the front end portion of the female differential pair.

In a possible design, the female conductive base forms an integrated structure by using an integrated molding process.

In a possible design, an elastic clamping piece is disposed on the first conductive separator.

In a possible design, the first conductive separator is detachably mounted on the female conductive base.

According to a third aspect, a connector assembly is provided, and includes the male connector provided in the first aspect and the female connector provided in the second aspect.

According to a fourth aspect, a communications device is provided, and the communications device includes the connector assembly provided in the third aspect.

### BRIEF DESCRIPTION OF THE DRAWINGS

FIG. 1 is a schematic diagram of an overall assembly structure of a male connector;

FIG. 2 is a schematic diagram of assembling a male connector;

FIG. 3 is a schematic diagram of a structure of a male conductive base from an angle of view;

FIG. 4 is a schematic diagram of a structure of a male conductive base from another angle of view;

FIG. 5 is a schematic diagram of a structure of a shielding sleeve;

FIG. 6 is a schematic diagram of a structure in which a male differential pair is mounted in an insulated positioning piece;

FIG. 7 is an exploded diagram of the structure in FIG. 6;

FIG. 8 is a schematic diagram of an overall assembly structure of a female connector;

FIG. 9 is an exploded schematic diagram of a female connector;

FIG. 10 is a schematic diagram of a structure of a female conductive base from an angle of view;

FIG. 11 is a schematic diagram of a structure of a female conductive base from another angle of view;

FIG. 12 is a schematic diagram of a structure of a female conductive base from still another angle of view;

FIG. 13 is a schematic diagram of a structure of a first conductive separator;

FIG. 14 is an exploded schematic diagram of a female conductive base;

FIG. 15 is a schematic diagram of assembling a differential module;

FIG. 16 is an exploded schematic diagram of a differential module;

FIG. 17 is a schematic diagram of mounting of a female differential pair and a shielding bridge;

FIG. 18 is a schematic cross-sectional diagram in which connector assemblies are mated to each other according to this application; and

FIG. 19 is a schematic diagram of a communications device according to this application.

### DETAILED DESCRIPTION OF ILLUSTRATIVE EMBODIMENTS

The following describes implementations of this application in detail. Examples of the implementations are shown in the accompanying drawings, where identical or similar reference numerals represent identical or similar elements or elements having identical or similar functions. The following implementations described with reference to the accompanying drawings are examples, and are intended to explain this application only, but cannot be understood as limitations on this application.

In the descriptions of this application, it should be understood that terms “first”, “second”, and “third” are merely used for description, and cannot be understood as an indication or implication of relative importance, or an implicit indication of a quantity of indicated technical features. Therefore, features defined as “first”, “second”, and “third” may explicitly or implicitly include one or more of the features. In the descriptions of this application, “a plurality of” means two or more than two, unless otherwise specifically limited.

In the description of this application, it should be noted that, unless otherwise expressly specified and limited, the terms “installation”, “connected”, and “connection” should be understood broadly. For example, a connection may be a fixed connection, a detachable connection, or an integrated connection. Alternatively, a connection may be a mechanical connection or an electrical connection, or may mean mutual communication. Alternatively, a connection may be a direct connection, or an indirect connection through an intermediate medium, or may be a connection between two elements or an interaction relationship between two elements. A person of ordinary skill in the art may interpret specific meanings of the foregoing terms in this application according to specific cases.

In descriptions of this application, it should be understood that, locations or location relationships indicated by terms “front”, “rear”, “inside”, “outside”, “horizontal”, and the like are locations or location relationships based on mounting, and are merely intended for ease of describing this application and simplifying descriptions, instead of indicating or implying that a mentioned apparatus or element needs to be provided on a specific location or constructed and operated on a specific location, and therefore cannot be understood as limitations on this application.

In the descriptions of this specification, it should be noted that the term “and/or” is merely an association relationship that describes associated objects, and represents that there may be three relationships. For example, A and/or B may represent three cases: only A exists, both A and B exist, and only B exists.

Embodiments of this application provide a male connector 10 and a female connector 20 that can be used in cooperation with the male connector 10. Compared with a connector in a conventional technology, the connector provided in this application has advantages such as convenient processing, great mechanical strength, and a good shielding effect.

According to a first aspect, an embodiment of this application first provides a male connector 10, and the male connector 10 is configured to be mounted on an external circuit board, and is configured to interconnect with a corresponding connector (for example, a female connector 20 provided in the following second aspect) to transmit a signal. The male connector in this application may also be referred to as a pin connector, a plug connector, a daughter board connector, or the like.

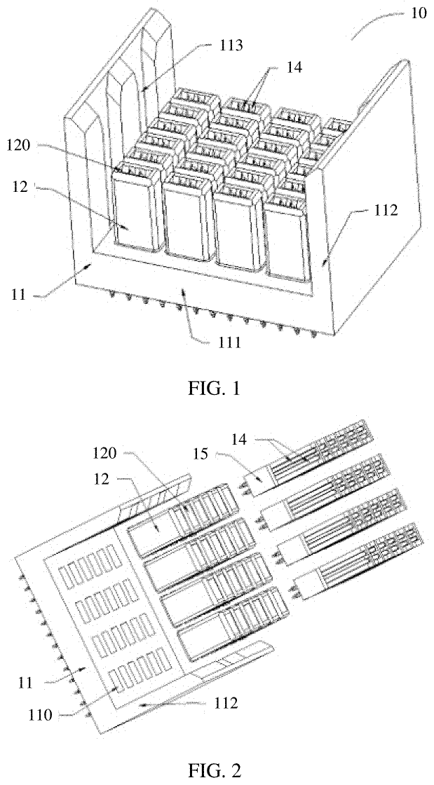

FIG. 1 is a schematic diagram of an overall assembly structure of the male connector 10 provided in this application. FIG. 2 is an exploded schematic diagram of the male connector 10 provided in this application. As shown in FIG. 1 and FIG. 2, the male connector 10 includes a male conductive base 11, a plurality of shielding sleeves 12, and a plurality of male differential pairs 14.

A plurality of first through-holes 110 are disposed on the male conductive base 11.

The plurality of shielding sleeves 12 are fastened on the male conductive base 11, and are electrically connected to the male conductive base 11. The shielding sleeve 12 is in a sleeve-shaped structure. A front-to-back through shielding cavity 120 is formed inside the shielding sleeve 12. The plurality of shielding sleeves 12 are in one-to-one correspondence with the plurality of first through-holes 110. The shielding cavity 120 is connected to a corresponding first through-hole 110.

The plurality of male differential pairs 14 are in one-to-one correspondence with the plurality of shielding sleeves 12. The male differential pair 14 is fastened in the shielding cavity 120 through the first through-hole 110. The male differential pair 14 is electrically insulated from the male conductive base 11 and the shielding sleeve 12.

Specifically, compared with a conventional base such as a plastic base that does not have a conducting capability, the male conductive base n1 in this application has the conducting capability, that is, has a function of shielding electromagnetic wave radiation. The plurality of first through-holes no are formed on the male conductive base 11. When the male differential pairs 14 are located in the first through-holes 110, the male conductive base 11 can shield electromagnetic waves generated by the male differential pairs 14 in the first through-holes 110.

In addition, the shielding sleeve 12 in this application also has the conducting capability, that is, has the function of shielding electromagnetic wave radiation. The shielding sleeve 12 is in the sleeve-shaped structure, and the front-to-back through shielding cavity 120 is formed inside the shielding sleeve 12. When the male differential pair 14 is disposed in the shielding cavity 120, the shielding sleeve 12 can also shield an electromagnetic wave generated by the male differential pair 14 in each shielding cavity 120.

The plurality of shielding sleeves 12 are all fastened on the male conductive base 11, and the shielding sleeves 12 are disposed in one-to-one correspondence with the first through-holes no, so that the shielding cavity 120 is connected to the corresponding first through-hole no, and the male differential pair 14 can extend into the shielding cavity 120 through the first through-hole no. In other words, space formed by the first through-hole no and the shielding cavity 120 that are connected to each other may be used to mount the male differential pair 14.

The plurality of male differential pairs 14 are in one-to-one correspondence with the plurality of shielding sleeves 12, and each male differential pair 14 is fastened in the shielding cavity 120 through the first through-hole 110. In addition, to shield the male differential pair 14, the male differential pair 14 in this application is electrically insulated from the male conductive base n1 and the shielding sleeve 12.

In this application, the plurality of shielding sleeves 12 are all electrically connected to the male conductive base 11. According to the foregoing disposing, a connection location between the shielding sleeve 12 and the male conductive base 11 can also shield the male differential pair 14, to prevent an electromagnetic wave generated by the male differential pair 14 from being leaked through the connection location, and in addition, the shielding sleeve 12 is electrically connected to the male conductive base 11, so that the shielding sleeve 12 can be grounded by using the male conductive base 11. In this way, it is ensured that the male connector 10 has reliable working performance.

Based on this embodiment of this application, both the male conductive base 11 and the shielding sleeve 12 of the male connector 10 have the conducting capability, and the male differential pair 14 is fastened in the first through-hole no and the shielding cavity 120. The male conductive base 11 and the shielding sleeve 12 can entirely bind electromagnetic wave radiation generated by each male differential pair 14 to a corresponding first through-hole no and a corresponding shielding cavity 120, to implement 360-degree full shielding for each male differential pair 14, so that crosstalk does not occur between different male differential pairs 14.

Compared with a conventional male connector in which a plurality of shielding sheets are disposed on a plastic base, the male connector 10 provided in this application has a simple structure and few parts, and is easy to produce and process. This facilitates a miniaturization design of a product. In this application, the shielding sleeve fastened on the male conductive base is in a sleeve-shaped structure. Compared with a conventional structure in which a plurality of shielding sheets are inserted into a plastic base, the male connector provided in this application has greater mechanical strength, and is not damaged due to a reversed pin in a process of being inserted and mated to a female connector.

A specific structure of the male connector 10 provided in this embodiment is further described below with reference to the accompanying drawings.

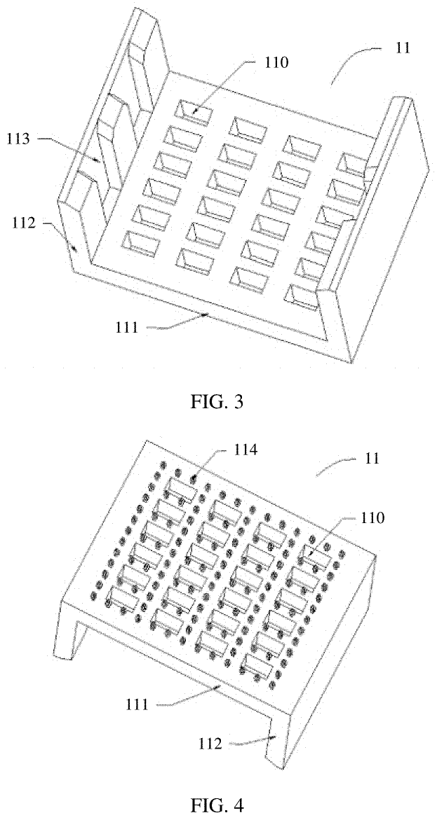

FIG. 3 is a schematic diagram of a structure of the male conductive base 11 from an angle of view. FIG. 4 is a schematic diagram of a structure of the male conductive base 11 from another angle of view. As shown in FIG. 3, in this embodiment of this application, the entire male conductive base n1 is in a U-shaped plate structure, and includes two opposite vertical plates 112 and a base plate 111 connecting the two vertical plates 112. During insertion and cooperation with a female connector, the female connector can be inserted into an opening of the U-shaped plate structure, and the two vertical plates 112 can be used to limit and support the female connector.

In another embodiment, the male conductive base 11 may alternatively be in another structure. For example, the male conductive base 11 does not include the vertical plates 112, or includes only one vertical plate 112. This is not limited in this application.

To implement reliable insertion and cooperation with the female connector, at least one positioning slot 113 may be disposed on an inner side face (that is, a side face facing an inner side of the U-shaped plate structure) of the vertical plate 112. The positioning slot 113 adapts to a positioning block of the female connector, and is configured to accommodate the positioning block.

As shown in FIG. 2 to FIG. 4, the plurality of first through-holes no are disposed on the base plate in, and the base plate in is configured to mount the shielding sleeves 12. The plurality of shielding sleeves 12 may be disposed in one-to-one correspondence with the plurality of through-holes 110, so that the first through-hole 110 and the shielding cavity 120 can be interconnected. In this way, the male differential pair 14 can extend into the shielding cavity 120 through the first through-hole 110.

The through-hole 110 penetrates the base plate 111, and the shielding sleeve 12 may be fastened on a front end face (that is, a side face facing the inner side of the U-shaped plate structure) of the base plate 111, so that the male differential pair 14 can be inserted into the first through-hole 110 from a rear end face (that is, a side face away from the inner side of the U-shaped plate structure) of the base plate 111, and is fastened in the shielding cavity 120 through the first through-hole 110.

As shown in FIG. 2 to FIG. 4, the plurality of first through-holes 110 may be arranged in a form of an array, so that the shielding sleeves 12 corresponding to the first through-holes 110 are also arranged in a form of an array. In another embodiment, the plurality of first through-holes 110 may alternatively be arranged in another manner. This is not limited in this application.

As shown in FIG. 4, to enable the male conductive base 11 to be reliably grounded, at least one grounding connection piece may be disposed on the male conductive base 11. For example, a plurality of grounding connection pieces 114 may be disposed on the rear end face of the base plate 111, and the grounding connection piece 114 can be inserted into an external circuit board. Optionally, the grounding connection piece 114 is in a fish-eye structure.

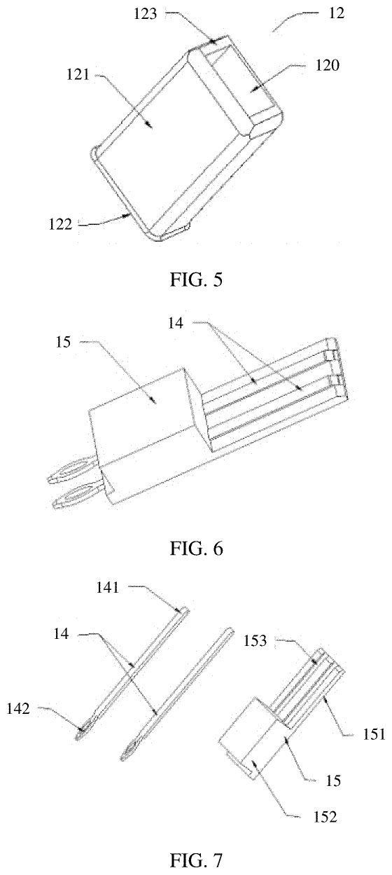

FIG. 5 is a schematic diagram of a structure of the shielding sleeve 12. As shown in FIG. 5, the shielding sleeve 12 is in a sleeve-shaped structure, and has a peripheral wall 121 in a 360-degree closed shape in a circumferential direction. The peripheral wall 121 defines a hollow front-to-back through shielding cavity 120.

The shielding sleeve 12 further includes a rear end portion 122 and a front end portion 123. The rear end portion 122 and the front end portion 123 each have an opening (that is, openings of the shielding cavity 120). The rear end portion 122 is connected to the base plate 11, and is configured to fasten the shielding sleeve 12 on the male conductive base 11, and the opening of the front end portion 123 is used for insertion of the female differential pair of the female connector, and reliable lapping of the male differential pair 14. For ease of insertion and cooperation, a chamfer may be opened on the front end portion 123 of the shielding sleeve 12. The chamfer may perform a correction function when there is a mismatch in an initial period of mating between the male connector and the female connector, and may also guide the female differential pair to smoothly enter the shielding cavity 120.

It is easy to understand that a height of the shielding sleeve 12 needs to match a length of the male differential pair 14. In one aspect, it needs to be ensured that the male differential pair 14 can entirely surround the male differential pair 14 in a circumferential direction after the male differential pair 14 is correctly mounted in the shielding cavity 120. In other words, in this case, the height of the shielding sleeve 12 needs to be greater than or equal to a length of a part that is of the male differential pair 14 and that extends into the shielding cavity 120. In another aspect, the shielding sleeve 12 further needs to ensure that a female deferential pair can reliably abut against the male differential pair 14 after the female deferential pair is normally inserted into the shielding sleeve 12. In other words, in this case, a part that is of the shielding sleeve 12 and that exceeds the male differential pair 14 should not be excessively long.

As shown in FIG. 1, FIG. 2, and FIG. 5, a cross section of the shielding sleeve 12 is a rectangle, and the entire shielding sleeve 12 forms a rectangular block structure. In another embodiment, the cross section of the shielding sleeve 12 may alternatively be in another shape. For example, the shielding sleeve 12 may be circular or oval, so that the entire shielding sleeve 12 forms a cylindrical structure. This is not limited in this application.

Optionally, to improve mechanical strength of the shielding sleeve 12, the shielding sleeve 12 may form an integrated structure by using an integrated molding process.

To reliably fasten the male differential pair 14 inside the shielding sleeve 12 and ensure electrical insulation between the male differential pair 14 and the shielding sleeve 12, the male connector 10 provided in this embodiment further includes an insulated positioning piece 15, and the male differential pair 14 may be fastened in the shielding cavity 120 by using the insulated positioning piece 15.

FIG. 6 is a schematic diagram of a structure in which the male differential pair 14 is mounted in the insulated positioning piece 15. FIG. 7 is an exploded diagram of the structure in FIG. 6.

As shown in FIG. 6 and FIG. 7, the male differential pair 14 includes two signal terminals, and each signal terminal includes a first elastic contact portion 141 at a front end and a first mounting portion 142 at a rear end. The first elastic contact portion 141 is configured to be reliably lapped on the female differential pair. Because the male connector 10 is mounted on a circuit board by using the first mounting portion 142, a differential signal is transmitted by using the first mounting portion 142, and the differential signal is transmitted to the female connector by using the first elastic contact portion 141.

The insulated positioning piece 15 is made of an insulated material. When the male differential pair 14 is reliably fastened in the shielding cavity 120, the male differential pair 14 and the shielding sleeve 12 can be separated from each other, so that the male differential pair 14 and the shielding sleeve 12 are electrically insulated.

Optionally, for ease of mounting, the insulated positioning piece 15 may be made of an elastic insulated material, such as an elastic rubber material.

In this embodiment of this application, the insulated positioning piece 15 includes two parts that are connected to each other, and the two parts are a terminal retaining portion 151 that is mounted at a front end and an embedded portion 152 that is mounted at a rear end.

The male differential pair 14 may be attached to a surface of the terminal retaining portion 151 after passing through the embedded portion 152 (for example, in a hard interference manner). The terminal retaining portion 151 can support and fasten the male differential pair 14.

Optionally, a positioning groove 153 is further disposed on the surface of the terminal retaining portion 151, and the male differential pair 14 may be embedded into the positioning groove 153 after passing through the embedded portion 152, so that a better fastening effect can be implemented for the male differential pair 14, and a reliable connection between the male differential pair 14 and the female differential pair can be ensured.

It is easy to understand that the insulated positioning piece 15 needs to adapt to a size of the first through-hole 110 and a size of the shielding cavity 120. For example, a size of the insulated positioning piece 15 may be slightly greater than the size of the first through-hole 110, and the embedded portion 152 may be embedded into the first through-hole 110 through interference fitting.

A specific structure of the male connector 10 is described in detail above. Texture of material and a manufacturing process that are of the male connector 10 are further described below.

Both the male conductive base 11 and the shielding sleeve 12 in this application have a conducting capability. Optionally, at least one of the male conductive base 11 and the shielding sleeves 12 may be made of a metal material. For example, the metal material may include at least one of materials such as copper, aluminum, stainless steel, aluminum alloy, and copper alloy.

Optionally, at least one of the male conductive base 11 and the shielding sleeve 12 may be made of a non-conductive material doped with conductive particles. For example, graphite powder (or metal powder) of a specific concentration may be added to insulated plastics to manufacture the male conductive base 11 and/or the shielding sleeve 12 with the conducting capability.

Optionally, at least one of the male conductive base 11 and the shielding sleeve 12 may be formed by disposing a conductive layer on a surface after making an ideal contour from a non-conductive material. For example, after an ideal contour is made from insulated plastics, a conductive layer may be formed on a surface by using a process such as electroplating or spraying, and finally, the male conductive base 11 and/or the shielding sleeve 12 with the conducting capability are/is manufactured.

While fastening the shielding sleeve 12 to the male conductive base 11, a reliable electrical connection between the male conductive base 11 and the shielding sleeve 12 also needs to be ensured. Optionally, the shielding sleeve 12 may be fastened on the male conductive base 11 by using a means such as welding, clamping, screw connection, or conductive adhesive bonding.

To further improve the mechanical strength of the male connector 10, in this embodiment of this application, the male conductive base 11 and the shielding sleeve 12 may form an integrated structure in an integrated molding manner.

Optionally, the foregoing integrated molding manner may be direct metal molding.

For example, the foregoing integrated structure obtained through integrated molding may be manufactured by using a powder metallurgy process by using metal powder. In this case, the male conductive base 11 and the shielding sleeve 12 have a conducting capability, and both the male conductive base 11 and the shielding sleeve 12 can also meet an electrical connection requirement. In addition, the male conductive base 11 and the shielding sleeve 12 are molded into an integrated structure by using an integrated molding process, so that a quantity of parts can be reduced, and the mechanical strength of the male connector 10 can be significantly improved.

In addition, the integrated structure may alternatively be manufactured by using another process such as casting. This is not limited in this application.

Optionally, the foregoing integrated structure may alternatively be manufactured by using an integrated molding process by using a non-conductive material doped with conductive particles.

For example, graphite powder (or metal powder) of a specific concentration may be added to insulated plastic, and finally, the foregoing integrated structure is manufactured by using the integrated molding process.

Optionally, a non-conductive substrate structure with an ideal contour may be manufactured by using the integrated molding process, and then a conductive layer is disposed on a surface (including an inner surface and an outer surface) of the non-conductive substrate structure by using a process such as electroplating or spraying. Finally, the male conductive base 11 and the shielding sleeve 12 with the conducting capability are formed.

According to another aspect, an embodiment of this application first provides a female connector 20, and the female connector 20 is configured to be mounted on an external circuit board, and is configured to be inserted into a corresponding connector (for example, the male connector 10 provided in the first aspect above) to transmit a signal. The female connector in this application may also be referred to as a pin connector, a socket connector, a mother board connector, or the like.

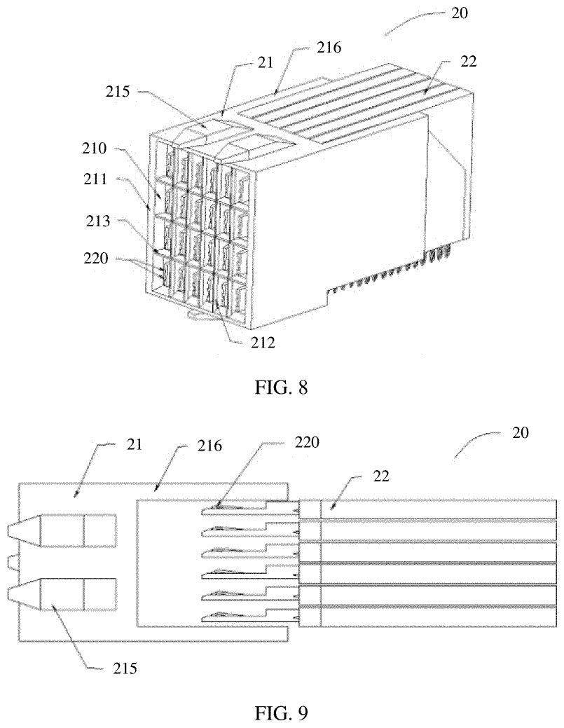

FIG. 8 is a schematic diagram of an overall assembly structure of the female connector 20 provided in this application. FIG. 9 is an exploded schematic diagram of the female connector 20 provided in this application. As shown in FIG. 8 and FIG. 9, the female connector 20 includes a female conductive base 21 and a plurality of differential modules 22.

A plurality of shielding slots 210 are formed on the female conductive base 21, and the shielding slot is in a sleeve-shaped structure.

The plurality of differential modules 22 are mounted on the female conductive base 21. The differential module 22 includes a plurality of female differential pairs 220. The plurality of female differential pairs 220 are in one-to-one correspondence with the plurality of shielding slots 210. A front end of the female differential pair 220 extends into the shielding slot 210. The female differential pair 220 is electrically insulated from the female conductive base 21.

Specifically, as shown in FIG. 8 and FIG. 9, the female connector 20 in this application includes the female conductive base 21. The female conductive base 21 has a conducting capability, that is, has a function of shielding electromagnetic wave radiation. The plurality of shielding slots 210 are formed on a fitting surface on which the female conductive base 21 is inserted into and engaged with a male connector. The shielding slot 210 is in a sleeve-shaped structure and extends to an inner side of the female conductive base 21.

The plurality of differential modules 22 are horizontally disposed in a stack, and are fastened on the female conductive base 21. Each differential module 22 includes a plurality of female differential pairs 220. The plurality of female differential pairs 220 of the plurality of differential modules 22 are in one-to-one correspondence with the plurality of shielding slots 210, and a front end of the female differential pair 220 extends into the shielding slot 210. Because the female conductive base 21 in this application has a conducting capability, the female connector 20 in this application further needs to ensure that the female differential pair 220 is electrically insulated from the female conductive base 21.

The female connector 20 in this application can be used in cooperation with the foregoing male connector 10. Specifically, the shielding slot 210 and the shielding sleeve 12 adapts to each other, and the shielding sleeves 12 are in one-to-one correspondence with the shielding slots 210. The shielding sleeve 12 can be inserted into the shielding slot 210, and after the shielding sleeve 12 is inserted into the shielding slot 210, the front end that is of the female differential pair 220 and that is in the shielding slot 210 can also be inserted into the shielding sleeve 12, and abuts against a front end portion (that is, the first elastic contact portion 141) that is of the male differential pair 14 and that is in the shielding sleeve 12, to transmit a differential signal.

The female connector 20 provided in this application includes a female conductive base 21. The plurality of shielding slots 210 are formed on the female conductive base 21, and the female conductive base 21 can bind electromagnetic wave radiation generated by a differential pair on each path to the shielding slot 210, so that crosstalk does not occur between differential pairs on different paths, and therefore signal transmission performance of the connector is improved.

In addition, the female conductive base 21 in this application can perform an electromagnetic shielding function. Therefore, no additional shielding part (for example, a metal shielding sheet) needs to be disposed. In this way, a structure of the female connector 20 is simplified, processing difficulty is reduced, and a miniaturization design of a product is facilitated.

A specific structure of the female connector 20 is further described below with reference to the accompanying drawings.

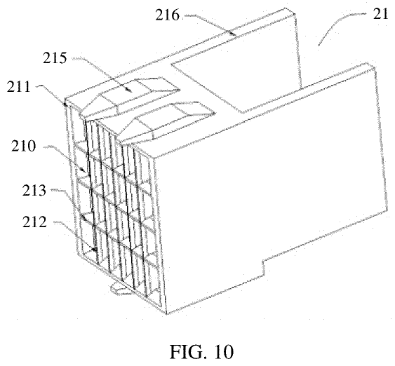

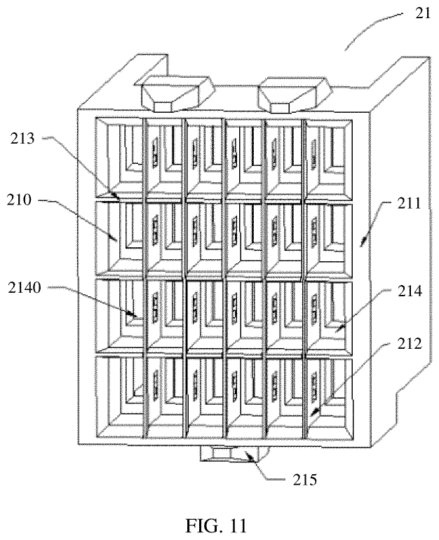

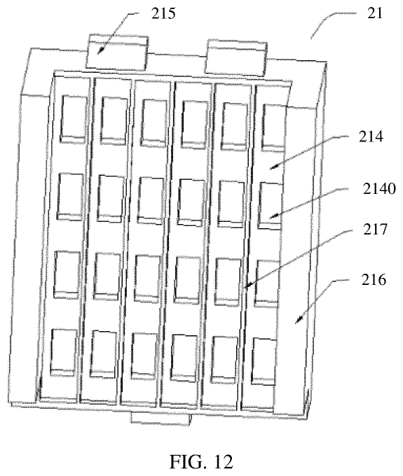

FIG. 10 is a schematic diagram of a structure of the female conductive base 21 from an angle of view. FIG. 11 is a schematic diagram of a structure of the female conductive base 21 from another angle of view. FIG. 12 is a schematic diagram of a structure of the female conductive base 21 from still another angle of view.

As shown in FIG. 10 to FIG. 12, in this embodiment of this application, the female conductive base 21 includes a conductive bezel 211, at least one first conductive separator 212, and at least one second conductive separator 213.

The conductive bezel 211 is in a 360-degree closed shape in a circumferential direction, to define inner space of the female conductive base 21. The first conductive separator 212 and the second conductive separator 213 are located inside the conductive bezel 211, and the first conductive separator 212 and the second conductive separator 213 are disposed in a cross manner to define the plurality of shielding slots 210. In other words, the first conductive separator 212 and the second conductive separator 213 are disposed in a cross manner, so that the inner space of the female conductive base 21 is separated into a plurality of pieces of space, to form the plurality of shielding slots 210.

It is easy to understand that a shape of the conductive bezel 211 and a shape of the base plate in of the male conductive base 11 need to adapt to each other, to ensure that the male connector and the female connector mate with each other.

As shown in FIG. 10 to FIG. 12, there may be a plurality of first conductive separators 212 in this application, and the plurality of first conductive separators 212 are parallel to each other. Similarly, there may also be a plurality of second conductive separators 213, and the plurality of second conductive separators 213 are parallel to each other. The conductive bezel 211 in this application is in a rectangular shape, and the first conductive separator 212 and the second conductive separator 213 are perpendicular to each other, to define a plurality of shielding slots 210 whose cross sections are rectangles.

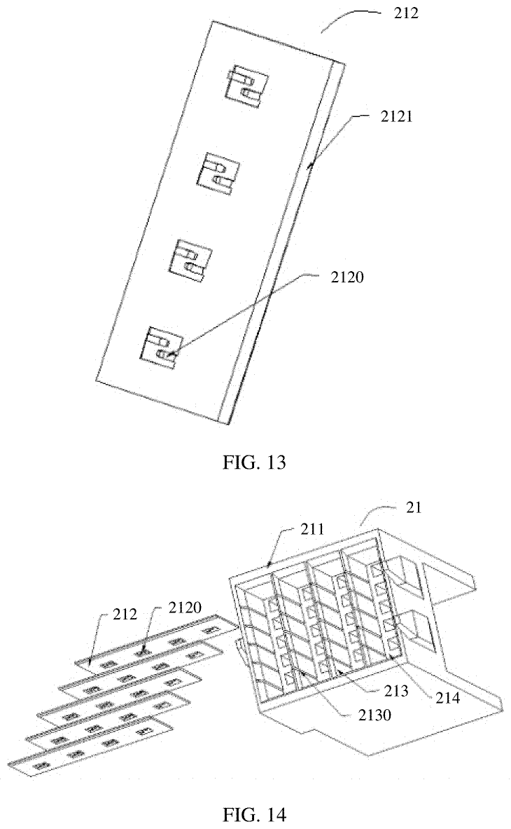

FIG. 13 is a schematic diagram of a structure of the first conductive separator 212. As shown in FIG. 13, for convenience of grounding, at least one elastic clamping piece 2120 is further disposed on the first conductive separator 212 in this embodiment of this application. After the shielding sleeve 12 is inserted into the shielding slot 210, the elastic clamping piece 2120 can abut against the shielding sleeve 12, so that the shielding sleeve 12 and the first conductive separator 212 are reliably electrically connected, in other words, a reliable electrical connection between the male conductive base 11 and the female conductive base 21 is ensured. In this way, it is convenient to ground the male conductive base 11 and the female conductive base 21.

Optionally, for ease of processing, the first conductive separator 212 may be detachably mounted on the female conductive base 21. In other words, the first conductive separator 212 may be separately manufactured and then mounted on the female conductive base 21.

FIG. 14 is an exploded schematic diagram of the female conductive base 21. As shown in FIG. 13 and FIG. 14, the first conductive separator 212 has an insertion side 2121, and a chamfer is disposed on the insertion side 2121. Correspondingly, a separator slot 2130 is disposed on the bezel 211 and the second conductive separator 213, and the separator slot 2130 matches a thickness of the first conductive separator 212. During assembly, the insertion side 2121 of the first conductive separator 212 may be inserted into the separator slot 2130 as a front end portion.

Optionally, to facilitate insertion and cooperation, at least one positioning block 215 is further disposed on an outer side of the conductive bezel 211. The positioning block 215 can be used in cooperation with the positioning slot 113 of the male connector 10 to perform better positioning during insertion and cooperation.

Optionally, a chamfer may be disposed at a front end of the positioning block 215, to further improve insertion and cooperation efficiency.

Optionally, a pair of limiting plates 216 are further disposed at a rear part of the conductive bezel 211, and the limiting plates 216 are disposed relative to each other, to more reliably fasten the differential module 22 on the female conductive base 21.

As shown in FIG. 11, FIG. 12, and FIG. 14, the female conductive base 21 further includes a conductive positioning baffle 214. The conductive positioning baffle 214 is disposed inside the female conductive base 21 and is located between the shielding slot 210 and the differential module 22. Second through-holes 2140 in one-to-one correspondence with the plurality of shielding slots 210 are disposed on the conductive positioning baffle 214. A front end of the female differential pair 220 extends into the shielding slot 210 through the second through-hole 2140.

During insertion and cooperation, the conductive positioning baffle 214 can be configured to abut against the shielding sleeve 12, to position the shielding sleeve 12. In addition, the conductive positioning baffle 214 has a conducting capability, that is, has a function of shielding electromagnetic wave radiation. The conductive positioning baffle 214 may perform electromagnetic shielding on a part (or a part in the second through hole 2140) that is of the female differential pair 220 and that is located between the differential module 22 and the shielding slot 210, so that mutual crosstalk between different differential pairs is reduced, and transmission performance of the female connector 20 is improved.

As shown in FIG. 11 and FIG. 14, to further improve a shielding effect, the shielding slot 210 may abut against the conductive positioning baffle 214. Specifically, the conductive positioning baffle 214 may abut against the first conductive separator 212 and the second conductive separator 213, to define the shielding slot 210 jointly with the first conductive separator 212, the second conductive separator 213, and the conductive positioning baffle 214, so that electromagnetic wave radiation does not leak out of a gap between the shielding slot 210 and the conductive positioning baffle 214.

As shown in FIG. 12, to better mount and fasten the differential module 22, and also to improve a shielding effect, in this embodiment of this application, at least one third conductive separator 217 is further disposed on a side face that is of the conductive positioning baffle 214 and that faces the differential module 22, and the third conductive separator 217 is configured to separate two adjacent differential modules 22. During assembly, the third conductive separator 217 may perform a positioning function, and only the differential module 22 needs to be inserted into a recess formed by two adjacent third conductive separators 217 (or the bezel and the third conductive separator 217). In addition, the third conductive separator 217 also has an electromagnetic shielding function, so that mutual crosstalk between two adjacent differential modules 22 can be reduced.

A specific structure of the differential module 22 in this application is described below with reference to the accompanying drawings.

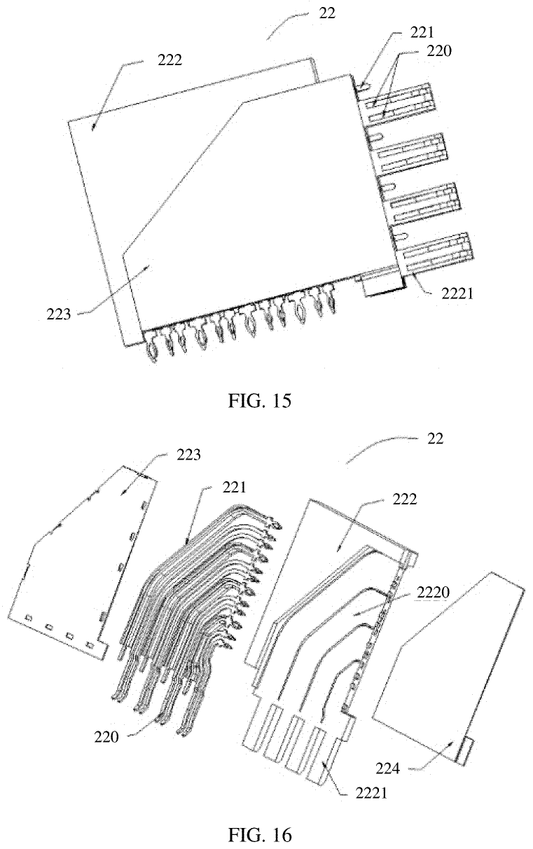

FIG. 15 is a schematic diagram of assembling the differential module 22. FIG. 16 is an exploded schematic diagram of the differential module 22. As shown in FIG. 15 and FIG. 16, the differential module 22 includes a female differential pair 220, a shielding bridge 221, an insulated sleeve 222, a first shielding plate 223, and a second shielding plate 224.

The insulated sleeve 222 is made of an insulated material (such as rubber), and is configured to mount the female differential pair 220, the shielding bridge 221, the first shielding plate 223, and the second shielding plate 224. The shielding bridge 221 can be electrically conductive, has an electromagnetic shielding function, and performs a shielding function between two adjacent differential pairs. The first shielding plate 223 and the second shielding plate 224 also have an electromagnetic shielding function, and are mainly configured to perform a shielding function between two adjacent differential modules 22.

A mounting groove 2220 is disposed on the insulated sleeve 222. The female differential pair 220 and the shielding bridge 221 may be disposed in the mounting groove 2220 in an interleaved manner, and the female differential pair 220 and the shielding bridge 221 are electrically insulated.

After the female differential pair 220 and the shielding bridge 221 are fastened in the mounting groove 2220, a height of the shielding bridge 221 is higher than a height of the female differential pair 220, the first shielding plate 223 covers the female differential pair 220 and the shielding bridge 221, and the second shielding plate 224 is disposed on the other side of the insulated sleeve 222 and is opposite to the first shielding plate 223.

The first shielding plate 223 is electrically connected to the shielding bridge 221 because the height of the shielding bridge 221 is higher than the height of the female differential pair 220. Therefore, a shielding cavity is formed by using the first shielding plate 223, the second shielding plate 224, and two adjacent shielding bridges 221, and the shielding cavity includes a differential pair 220, so that 360-degree full shielding can be implemented for the differential pair 220.

Optionally, the first shielding plate 223 and the second shielding plate 224 may be fastened on the insulated sleeve 222 through clamping.

Optionally, the mounting groove 2220 matches the female deferential pair 220 or the shielding bridge 221, and the female deferential pair 220 or the shielding bridge 221 may be fastened on the insulated sleeve 222 through embedding.

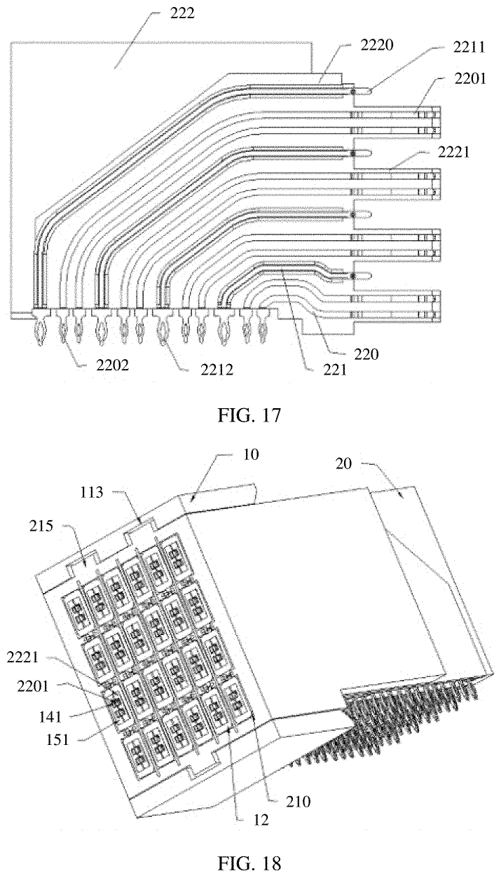

FIG. 17 is a schematic diagram of mounting of the female differential pair 220 and the shielding bridge 221. As shown in FIG. 17, the female differential pair 220 and the shielding bridge 221 may be mounted on the insulated sleeve 222 in an interleaved manner, and one shielding bridge 221 is disposed between two adjacent female differential pairs 220.

The female differential pair 220 may include a second elastic contact portion 2201 (that is, the foregoing front end portion) and a second mounting portion 2202. The second elastic contact portion 2201 may extend into the shielding slot 210 through the second through-hole 2140. Further, after insertion and mating are completed, the second elastic contact portion 2201 may extend into the shielding sleeve 12 and come into contact with the first elastic contact portion 141 of the male differential pair 12, to transmit a differential signal. The second mounting portion 2202 is connected to an external device (for example, a circuit board), and is configured to transmit a differential signal.

As shown in FIG. 17, to reliably dispose the second elastic contact portion 2201 in the shielding slot 210, and to ensure that the second elastic contact portion 2201 is electrically insulated from the shielding slot 210, the insulated sleeve 222 further includes a terminal supporting portion 2221, and the terminal supporting portion 2221 is configured to support the second elastic contact portion 2201, and extends into the shielding slot 210 together with the second elastic contact portion 2201.

Optionally, a chamfer is disposed at a front end portion of the terminal supporting portion 2221, and when being mated to male differential pairs, the chamfer can serve as a guide.

FIG. 17 also shows a specific structure of the shielding bridge 221. The shielding bridge 221 in this application includes a third elastic contact portion 2211 and a third mounting portion 2212 that are located at the front end portion. The third elastic contact portion 2211 is used to abut against a conductive positioning baffle 214, and the third mounting portion 2212 is used to be connected to an external device (such as a PCB) to be grounded.

The female connector 20 provided in this embodiment of this application may successively bind electromagnetic wave radiation generated by differential pairs to shielding space formed by using the shielding slot 210, the second through-hole 2140, the third conductive separator 215, and the shielding bridge 221 and shielding space formed by using the first shielding plate 223, the second shielding plate 224, and the shielding bridge 221, so that 360-degree full shielding for the differential pairs can be implemented on an entire transmission path. In this way, it is ensured that crosstalk does not occur between different differential pairs, and use performance of the connector is improved.

To further improve mechanical strength of the female connector 20, in this embodiment of this application, the female conductive base 21 may form an integrated structure in an integrated molding manner.

Optionally, the foregoing integrated molding manner may be direct metal molding.

For example, the integrated female conductive base 21 may be manufactured by using a powder metallurgy process by using metal powder. The female conductive base 21 is formed integrally, so that a quantity of parts can be reduced, and the mechanical strength of the female connector 20 can be significantly improved.

In addition, the integrated female conductive base 21 may alternatively be manufactured by using another process such as casting. This is not limited in this application.

Optionally, the female conductive base 21 may alternatively be manufactured by using an integrated molding process by using a non-conductive material doped with conductive particles.

For example, graphite powder (or metal powder) of a specific concentration may be added to insulated plastic, and finally, the foregoing integrated structure is manufactured by using the integrated molding process.

Optionally, a non-conductive substrate structure with an ideal contour may be manufactured by using the integrated molding process, and then a conductive layer is disposed on a surface (including an inner surface and an outer surface) of the non-conductive substrate structure by using a process such as electroplating or spraying. Finally, the female conductive base 21 with a conducting capability is formed.

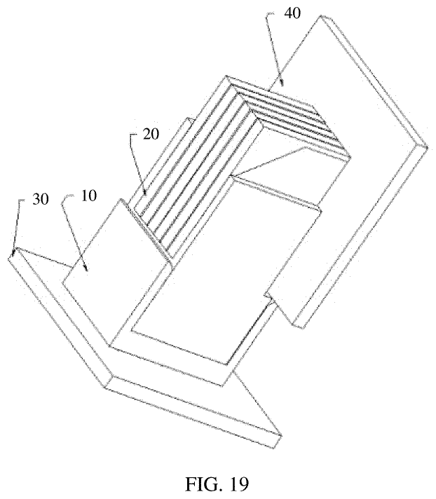

According to another aspect, this application further provides a connector assembly. FIG. 18 is a schematic cross-sectional diagram in which connector assemblies are mated to each other according to this application. As shown in FIG. 18, the connector assembly includes the foregoing male connector 10 and the foregoing female connector 20. The male connector 10 is mated to the female connector 20. For specific structural features of the male connector 10 and the female connector 20, refer to the foregoing descriptions of the detailed structural features. Details are not described herein again.

In FIG. 18, a positioning block 215 of the female connector 20 is inserted into a positioning slot 113 of the male connector 10, and a shielding sleeve 12 of the male connector 10 is inserted into a shielding slot 210 of the female connector 20. A front end portion (that is, a second elastic contact portion 2201) that is of the female differential pair 220 and that is in the shielding slot 210 can also be inserted into the shielding sleeve 12, and abuts against a front end portion (that is, a first elastic contact portion 141) that is of the male differential pair 14 and that is in the shielding sleeve 12, to transmit a differential signal. A terminal retaining portion 151 and a terminal supporting portion 2221 can be used to ensure reliable lapping between the first elastic contact portion 141 and the second elastic contact portion 2201, and also ensure that the differential pair can be electrically insulated from the shielding sleeve 12.

According to another aspect, this application further provides a communications device. The communications device includes the connector assembly provided in the foregoing embodiment shown in FIG. 18, that is, includes the male connector 10 and the female connector 20.

FIG. 19 is a schematic diagram of a communications device according to this application. In FIG. 19, the communications device further includes a first circuit board 30 and a second circuit board 40. The male connector 10 is connected to an interface of the first circuit board 30, the female connector 20 is connected to an interface of the second circuit board 40, and the male connector 10 is mated to the female connector 20, so that a differential signal can be transmitted between the first circuit board 30 and the second circuit board 40.

Optionally, the first circuit board 30 and the second circuit board 40 may be printed circuit boards (PCB).

Crosstalk does not occur between different deferential pairs of the male connector 10 and the female connector 20 provided in this application. This helps improve communication performance of the communications device and reduce radiation of the communications device.

The foregoing descriptions are merely specific implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A male connector, comprising:
a male conductive base, wherein the male conductive base comprises at least two first through-holes;
at least two shielding sleeves fastened on the male conductive base and electrically connected to the male conductive base, wherein each of the at least two shielding sleeves sleeve-shape, wherein each shielding sleeve of the at least two shielding sleeve defines a front-to-back through shielding cavity, and wherein the shielding cavity is connected to a corresponding first through-hole of the at least two first through-holes; and
at least two male differential pairs, wherein each male differential pair of the at least two male differential pairs is fastened in the shielding cavity through at least one of the at least two first through-holes, and wherein each male differential pair is electrically insulated from the male conductive base and the shielding sleeve.

2. The male connector according to claim 1, further comprising an insulated positioning piece, wherein each male differential pair of the at least two male differential pairs is fastened in the shielding cavity using the insulated positioning piece.

3. The male connector according to claim 1, wherein at least one grounding connection piece is disposed on the male conductive base.

4. The male connector according to claim 1, wherein the male conductive base and at least one shielding sleeve of the at least two shielding sleeves form an integrated structure.

5. The male connector according to claim 1, wherein one or more of the male conductive base and at least one shielding sleeve of the at least two shielding sleeves comprises a non-conductive substrate structure and a conductive layer, and wherein the conductive layer is located on a surface of the non-conductive substrate structure.

6. The male connector according to claim 1, wherein the at least two shielding sleeves are in one-to-one correspondence with the at least two first through-holes.

7. The male connector according to claim 1, wherein the at least two male differential pairs are in one-to-one correspondence with the at least two shielding sleeves.

8. The male connector according to claim 1, wherein at least one shielding sleeve of the at least two shielding sleeves comprises a chamfer.

9. The male connector according to claim 1, wherein a height of each shielding sleeve of the at least two shielding sleeves is greater than, or equal to, a length of a part that is of a male differential pair of the at least two male differential pairs and that extends into the shielding cavity.

10. The male connector according to claim 1, wherein at least one shielding sleeve of the at least two shielding sleeves has a columnar shape, and wherein a cross section of a columnar structure of the shielding sleeve is one of oval, circular, or rectangular.

11. The male connector according to claim 1, further comprising an insulated positioning piece, wherein the insulated positioning piece is configured to fasten at least one male differential pair of the at least two male differential pairs in the shielding cavity.

12. The male connector according to claim 11, wherein the insulated positioning piece comprises a first part and a second part, wherein the first part is connected to the second part, wherein the first part is mounted as a terminal retaining portion at a front end, and wherein the second part is mounted as an embedded portion at a rear end.

13. The male connector according to claim 12, wherein the surface of the terminal retaining portion has a positioning groove, and wherein at least one male differential pair of the at least two male differential pairs is at least partially embedded into the positioning groove and extends through the embedded portion.

14. The male connector according to claim 12, wherein the embedded portion is embedded into at least one through-hole of the at least two first through-holes by interference fitting.

15. The male connector according to claim 11, wherein the insulated positioning piece is configured to adapt to a size of at least one through-hole of the at least two first through-holes and is further configured to adapt to a size of the shielding cavity.

16. The male connector according to claim 11, wherein a size of the insulated positioning piece is slightly greater than a size of at least one through-hole of the at least two first through-holes.

17. A connector assembly, comprising:
a male connector, wherein the male connector comprises:
a male conductive base having at least two first through-holes;
at least two shielding sleeves fastened on the male conductive base and electrically connected to the male conductive base, wherein the shielding sleeve is in a sleeve-shaped structure, a front-to-back through shielding cavity is formed inside the shielding sleeve, and the shielding cavity is connected to a corresponding first through-hole; and
at least two male differential pairs, wherein at least one male differential pair of the at least two male differential pairs is fastened in the shielding cavity through at least one through-hole of the at least two first through-holes, and wherein at least one male differential pair of the at least two male differential pairs is electrically insulated from the male conductive base and the shielding sleeve.

18. A communications device, comprising:
a connector assembly, comprising a male connector, wherein the male connector comprises:
a male conductive base, wherein the male conductive base has at least two first through-holes;
at least two shielding sleeves fastened on the male conductive base and electrically connected to the male conductive base, wherein at least one shielding sleeve of the at least two shielding sleeves has a sleeve-shaped structure, wherein at least one shielding sleeve of the at least two shielding sleeves defines a front-to-back through shielding cavity, and wherein each shielding sleeve of the at least two shielding sleeves is connected to a corresponding first through-hole of the at least two first through-holes; and
at least two male differential pairs, wherein at least one the male differential pair of the at least two male differential pairs is fastened in the shielding cavity through a first through-hole of the at least two first through-holes, and wherein at least one male differential pair of the at least two male differential pairs is electrically insulated from the male conductive base and the shielding sleeve.

19. The communications device according to claim 18, further comprising a first circuit board and a second circuit board, wherein the male connector is connected to an interface of the first circuit board, and wherein a female connector is connected to an interface of the second circuit board.

20. The communications device according to claim 19, wherein one or more of the first circuit board and the second circuit board is a printed circuit board (PCB).
